(19) United States
(12) Patent Application Publication
(10) Pub. No.: US 2016/0185653 A1
(43) Pub. Date: Jun. 30, 2016

(54) SILICATE CERAMICS, PLATE-LIKE SUBSTRATE, AND METHOD OF PRODUCING PLATE-LIKE SUBSTRATE

(71) Applicant: HOYA CORPORATION, Tokyo (JP)

(72) Inventor: Takashi FUSHIE, Tokyo (JP)

(73) Assignee: HOYA CORPORATION, Tokyo (JP)

(21) Appl. No.: 14/911,344

(22) PCT Filed: Aug. 27, 2014
(86) PCT No.: PCT/JP2014/072372

§ 371 Date: Feb. 10, 2016

(30) Foreign Application Priority Data
Sep. 4, 2013 (JP) 2013-183239

(51) Int. Cl. C03C 10/00; C03B 32/02; C03B 25/02; C03C 4/04

(52) U.S. Cl. CPC C03C 10/0027; C03C 4/04; C03B 32/02; C03B 25/025

(57) ABSTRACT

There is provided a silicate ceramics formed by crystallizing a silicate glass containing at least silicon oxide and lithium oxide, wherein a crystallinity of the silicate ceramics is 95% or more, and the silicate ceramics has a lithium disilicate crystal phase and α-quartz crystal phase, and further, regarding the ratio of the lithium disilicate crystal phase and the α-quartz crystal phase in the silicate ceramics, the lithium disilicate crystal phase has a larger weight ratio, and the silicate glass is preferably a photosensitive glass.

### TECHNICAL FIELD

The present invention relates to silicate ceramics, a plate-like substrate and a method of producing a plate-like substrate, and specifically relates to a silicate ceramics formed by crystallizing a silicate glass, a plate-like substrate made of the silicate ceramics, and a method of producing the same.

### DESCRIPTION OF RELATED ART

An interposer is known as a relay interposed between a semiconductor device and a substrate, and configured to electrically connect the semiconductor device and the substrate. Also, a gas electron amplifier utilizing an avalanche amplification, is known as a detector for detecting a particle beam or an electromagnetic wave.

A point common in the interposer and the gas electron amplifier, is a use of a substrate having a very large number of fine through holes formed thereon. A substrate with through holes filled with a conductive metal, is used for the interposer, and a substrate with both surfaces formed so that the through holes are not covered with an electrode for accelerating electrons, is used for the gas electron amplifier. Accordingly, in such a purpose of use, fine processing is required to be applied to the substrate, such as forming the through holes thereon.

Conventionally, Si wafer has been used as a substrate constituting the interposer (for example, see patent document 1). Although the Si wafer is easy for applying fine processing thereto, it is expensive, thus involving a problem in terms of a cost. On the other hand, a base material made of polyimide has been used as a substrate for the gas electron amplifier (for example, see patent document 2). However, the gas electron amplifier has a problem that a discharge easily occurs due to a high voltage applied for obtaining a high amplification factor, and polyimide having a low mechanical performance, is deteriorated due to such a discharge.

Incidentally, a photosensitive glass is the glass in which only an exposed portion is crystallized by exposing and applying heat treatment to the silicate glass containing a photosensitive component and a sensitizing component. In the crystallized portion, a dissolution rate to acid is very fast, compared with a non-crystallized portion. Accordingly, by utilizing such a property, selective etching can be applied to the photosensitive glass. According to such a selective etching, a plurality of through holes can be simultaneously formed. As a result, fine processing can be applied to the photosensitive glass inexpensively, without using the mechanical processing.

### PRIOR ART DOCUMENT

### Patent Document

Patent document 1: Japanese Patent Laid Open Publication No. 2009-277895
Patent document 2: Japanese Patent Laid Open Publication No. 2006-302844

### SUMMARY OF THE INVENTION

### Problem to be Solved by the Invention

Therefore, use of the photosensitive glass having a more excellent mechanical performance than polyimide, has started at a lower cost than the Si wafer, for the substrate, etc., such as the substrate for the interposer, the substrate for the gas electron amplifier, and the substrate for IPD (Integrated Passive Device).

Recently, in the abovementioned application, a high performance and a low cost of a device having them mounted thereon, are requested in the abovementioned application. Therefore, the following points are requested for the substrate used for the abovementioned application: a reduction of a substrate thickness, an enlargement of a substrate size, and a high through hole density by forming a finer diameter of each through hole, while reducing a cost.

In order to realize such a request, the mechanical performance of the substrate is required to be excellent. However, although the abovementioned photosensitive glass has an excellent mechanical performance as a glass, this is not sufficient to realize the abovementioned request.

In view of the above-described circumstance, the present invention is provided, and an object of the present invention is to provide a plate-like substrate made of a material suitable for fine processing, having an excellent mechanical performance, and having an excellent mechanical performance even if it is thin in thickness, and a method of producing this plate-like substrate.

### Means for Solving the Problem

It is found by the inventors of the present invention that the abovementioned problem can be solved by crystallizing the silicate glass to form a ceramics (polycrystal) having a significantly high crystallinity, and controlling a ratio of a crystalline phase precipitated by crystallization, and thus, the present invention is completed.

That is, according to an aspect of the present invention, there is provided a silicate ceramics formed by crystallizing a silicate glass containing at least silicon oxide and lithium oxide, wherein a crystallinity of the silicate ceramics is 95% or more, and the silicate ceramics has a lithium disilicate crystal phase and α-quartz crystal phase, and regarding the ratio of the lithium disilicate crystal phase and the α-quartz crystal phase in the silicate ceramics, the lithium disilicate crystal phase has a larger weight ratio.

In the above aspect, preferably the ratio of the lithium disilicate crystal phase and the α-quartz crystal phase is 60:40 to 80:20 by weight ratio.

In the above aspect, preferably the silicate glass is a photosensitive glass.

In the above aspect, preferably a bending strength of the silicate ceramics is 130 MPa or more.

In the above aspect, preferably a crystallite size of the lithium disilicate crystal and the α-quartz crystal phase is within a range of 20 to 30 nm.

According to another aspect of the present invention, there is provided a plate-like substrate made of the silicate ceramics of the above aspect, and having a plurality of through holes thereon, with a thickness of 1.0 mm or less.

In the above aspect, a diameter of the plate-like substrate is 50 mm or more.

According to another aspect of the present invention, there is provided a method of producing a plate-like base material, including:

applying a fine processing to a plate-like base material made of a photosensitive glass containing at least silicon oxide and lithium oxide; and

crystallizing a photosensitive glass by heat treatment after the fine processing, to obtain a plate-like substrate made of the silicate ceramics of the above aspect.

In the above aspect, preferably the photosensitive glass is annealed after holding it at a temperature range of 800 to 900° C. in the heat treatment.

### Advantage of the Invention

According to the present invention, it is possible to provide a plate-like substrate made of a material suitable for fine processing, having an excellent mechanical performance, and having an excellent mechanical performance even if it is thin in thickness, and a method of producing this plate-like substrate.

### BRIEF DESCRIPTION OF THE DRAWINGS

FIG. 1 is a schematic view showing the steps of producing a plate-like substrate in a production method according to an embodiment.

FIG. 2 is a view showing an X-ray diffraction profile according to an example of the present invention.

### DETAILED DESCRIPTION OF THE INVENTION

The present invention will be described in detail in the following order, based on an embodiment shown in the figure.

1. Photosensitive glass
2 Silicate ceramics
3 Plate-like substrate
4 Method of producing the plate-like substrate
5 Effect of this embodiment
6 Modified example, etc.

The silicate ceramics of this embodiment is formed by crystallizing a silicate glass containing at least silicon oxide and lithium oxide. In this embodiment, a photosensitive glass is used as the silicate glass, to facilitate fine processing by selective etching utilizing a difference in solubility to acid. First, the photosensitive glass will be described.

### 1. Photosensitive Glass

In this embodiment, the photosensitive glass is the glass containing Au, Ag, and Cu as photosensitive components in SiO₂—Li₂O—Al₂O₃-based glass, and further containing CeO₂ as a sensitizing component, and more specifically, for example this is the composition containing SiO₂: 55 to 85 mass %, Al₂O₃: 2 to 20 mass %, Li₂O: 5 to 15 mass %, SiO₂, Al₂O₃ and Li₂O: 85 mass % or more in total based on an entire body of the photosensitive glass, and Au: 0.001 to 0.05 mass %, Ag: 0.001 to 0.5 mass %, Cu₂O: 0.001 to 1 mass % as photosensitive components, and further CeO₂: 0.001 to 0.2 mass % as sensitizing components.

In such a photosensitive glass, crystallization is advanced by applying heat treatment thereto. In the case of the abovementioned photosensitive glass, two types of crystallizations are advanced depending on a temperature during heat treatment. In this embodiment, such two types of crystallizations are respectively called a first crystallization and a second crystallization.

The first crystallization is advanced by the heat treatment within a range of 450 to 600° C., and in this embodiment, it is performed so that the abovementioned fine processing can be performed. In the first crystallization, first, the photosensitive glass is irradiated with a UV-ray, and an energy of the UV-ray causes electrons to be released from a sensitizing component (CeO₂, etc.), and an ion of the photosensitive component (such as Au, Ag, and Cu, etc.) captures the electrons, thus generating metal atoms of the photosensitive component in the photosensitive glass. Subsequently, due to the heat treatment, the metal atoms present in the glass are agglomerated to form a colloid, and a crystal of lithium monosilicate (Li₂O—SiO₂) is precipitated, with this colloid as a crystal nuclei. The crystal of the lithium monosilicate has a higher solubility to hydrogen fluoride, than the solubility of a non-crystallized glass portion. Therefore, by utilizing such a performance, the fine processing can be performed.

### 2. Silicate Ceramics

In this embodiment, the abovementioned photosensitive glass is subjected to the fine processing utilizing the first crystallization, and thereafter crystallized by the second crystallization, and converted to the silicate ceramics. In other words, the silicate ceramics is a polycrystalline body obtained through an amorphous glass.

The second crystallization is advanced by the heat treatment in a range of 800 to 900° C., and in this embodiment, the second crystallization is performed to obtain the polycrystalline body. In the second crystallization, by performing the heat treatment at a higher temperature than the first crystallization, precipitations of a crystal of the lithium disilicate (Li₂O-2SiO₂) and a crystal of α-quarts are started. Regarding the crystal of the lithium disilicate, the following two cases can be considered: the lithium disilicate is directly precipitated in the glass by the heat treatment in the second crystallization, and the lithium disilicate is precipitated by binding of the crystal of the lithium monosilicate which is precipitated by the first crystallization, and the silicon oxide (SiO₂) in the glass. The photosensitive glass is crystallized with an advancement of the second crystallization, and the silicate ceramics of this embodiment is formed. Accordingly, the silicate ceramics is the polycrystalline body composed of many crystals, and is not any more an amorphous body such as the photosensitive glass.

In this embodiment, the crystallinity showing a content ratio of the crystal with respect to the entire body of the silicate ceramics, is 95% or more. Accordingly, the silicate ceramics of this embodiment is mainly composed of the crystal, and almost no amorphous phase is contained therein.

The glass formed by crystallizing the photosensitive glass is generally called a crystallized glass. However, such a crystallized glass is the glass in which the crystal is precipitated on the entire body of the photosensitive glass, but it cannot be said that the entire body of the photosensitive glass is crystallized. For example, the crystallinity of PEG3C by HOYA Corporation, which is a crystallized photosensitive glass, is about 30%.

Accordingly, the crystallinity of the silicate ceramics of this embodiment is significantly higher than a normal crystallized glass.

The abovementioned crystallinity is calculated as a total of two crystal phases constituting the silicate ceramics. That is, the silicate ceramics is composed of the crystal phase of the lithium disilicate and the crystal phase of the α-quartz. The ratio of the lithium disilicate crystal phase is larger by weight ratio. The ratio of the crystal phase by weight ratio is as follows: preferably, lithium disilicate: α-quartz=60:40 to 80:20, and further preferably 65:35 to 75 to 25. According to a structure in which the crystal phase of the silicate ceramics is composed of the abovementioned two crystal phases, and further the ratio of the crystal phase is set in the abovementioned range, a mechanical performance of the silicate ceramics can be improved.

Preferably, the silicate ceramics of this embodiment does not contain a phase other than the abovementioned two phases, for example does not contain the crystal phase of the lithium monosilicate (Li₂O—SiO₂). This is because when the crystal phase of the lithium monosilicate is present in the silicate ceramics of this embodiment, the mechanical performance of the silicate ceramics is likely to deteriorate.

Also preferably, the crystal phase of the lithium disilicate and the crystal phase of the α-quartz are composed of a significantly fine crystal, and a size of this crystal coincides with a crystallite size. In this embodiment, the crystallite size of the lithium disilicate crystal and the α-quartz crystal is preferably in a range of 20 to 30 nm.

A grain boundary is formed between crystal grains constituting the lithium disilicate crystal phase, between crystal grains constituting the α-quartz crystal phase, or between crystal grains constituting the lithium disilicate crystal phase and crystal grains constituting the α-quartz crystal phase. It is conceivable that a component not incorporated in the lithium disiilcate crystal phase and the α-quartz crystal phase, is present in the grain boundary. Accordingly, it is conceivable that a component other than silicon oxide and lithium oxide (for example, aluminum oxide, photosensitive component, and sensitizing component) is present in the grain boundary.

In this embodiment, the abovementioned crystallinity, the weight ratio of the crystal phase, and the crystallite size, are calculated using an X-ray diffraction method.

From an X-ray diffraction profile obtained by an X-ray diffraction measurement, the crystallinity is obtained as follows: an X-ray scattering intensity is divided into a scattering intensity due to crystal (crystal scattering intensity) and a scattering intensity (non-crystal scattering intensity) due to an amorphous material. Then, the crystallinity is calculated as a ratio of the crystal scattering intensity to a total scattering intensity (crystal scattering intensity and non-crystal scattering intensity), as shown in the following formula (1).

Crystallinity (%)=100×(crystal scattering intensity)/(crystal scattering intensity+non-crystal scattering intensity) Formula (1)

In the X-ray diffraction profile obtained by the X-ray diffraction measurement, the weight ratio of the crystal phase is calculated by an intensity ratio of a peak intensity derived from the lithium disilicate and a peak intensity derived from the α-quartz. Specifically, when the intensity of the peak shown by the X-ray diffracted on the (111) plane of the lithium disilicate is indicated by IL, and the intensity of the peak shown by the X-ray diffracted on the (011) plane of the α-quartz is indicated by Iq, IL:Iq=60:40 to 80:20.

The crystallite size is calculated from the equation of Scherrer (Scherrer) using a half-width value of a specific peak in the X-ray diffraction profile obtained by the X-ray diffraction measurement. In this embodiment, the lithium disilicate is calculated using the half-width value of the peak of the (111) plane, and the α-quartz is calculated using the half-width value of the peak of the (011) plane.

As will be described later, it is found by the inventors of the present invention that the abovementioned crystallinity and the weight ratio of the crystal phase can be controlled by a heat treatment temperature and a temperature decreasing speed during an annealing after keeping the temperature at the heat treatment temperature.

As described above, the silicate ceramics of this embodiment is the polycrystalline body, having a high crystallinity, wherein the weight ratio of the crystal phase is controlled in a specific range. Thus, the silicate ceramics having an excellent mechanical performance can be obtained. For example, a bending strength is given as one of the mechanical properties, and the bending strength of the silicate ceramics of this embodiment is 130 MPa or more. Incidentally, the bending strength may be measured in compliance with JIS R 1601.

### 3. Plate-Like Substrate

The plate-like substrate is made of the abovementioned silicate ceramics. The plate-like substrate may have a circular plate shape, or a rectangular plate shape such as oblong or square shape. In this embodiment, the plate-like substrate has a thickness of 1.0 mm or less. Since the plate-like substrate is made of the silicate ceramics, the mechanical performance is excellent even if it is thin in the thickness.

Although a size of the plate-like substrate is not particularly limited, the effect of the present invention is remarkably exhibited when the size of the plate-like substrate is 50 mm or more. In the present invention, the size of the plate-like substrate means a diameter when the plate-like substrate is the circular plate shape, and means a length of a side when the plate-like substrate has the rectangular shape.

Further, in this embodiment, as a result of the fine processing applied to the plate-like substrate, a plurality of through holes are formed on the plate-like substrate so that they are regularly arranged on a main surface of the substrate. A shape of each through hole is not particularly limited, but normally it is a circular shape in plan view. Also, a diameter of the through hole is about 5 to 100 μm, and an arrangement pitch of the through holes is about 10 to 300 μm. That is, the plate-like substrate is the substrate having significantly large numbers of (several thousands to several million) fine through holes formed thereon. A method of forming the through holes will be described later.

The plate-like substrate having the through holes formed thereon, is applied to an interposer or a gas electron amplifying substrate, etc. When it is applied to the interposer, the through hole of this substrate is filled with a conductive metal, and conduction between front and rear surfaces is secured. Further, when it is applied to the gas electron amplifying substrate, an electrode is formed on the front and rear surfaces so as not to cover the through holes.

### 4. Method of Producing the Plate-Like Substrate

The plate-like substrate is produced by forming a latent image on a base material composed of the photosensitive glass and crystallizing the latent image and thereafter dissolving and removing it to form the through holes, and crystallizing the photosensitive glass so as to be converted to the silicate ceramics. First, the photosensitive glass constituting the base material is produced.

A material of the component constituting the photosensitive glass is prepared as a starting material. As such a starting material, oxide of the component or a composite oxide, etc., can be used. Further, Various compounds to become oxides and composite oxides can be used at the time of melting. As those to become oxides, for example, carbonates, oxalates, nitrates, hydroxides, or the like can be used.

The prepared starting material was weighed and mixed so as to be a prescribed composition ratio, to thereby obtain a raw material mixture. The obtained raw material mixture was put in a melting vessel (for example, a platinum crucible, etc.), and melted. A temperature during melting may be suitably set according to a composition of the photosensitive glass, and in this embodiment, the temperature is set to about 1400 to 1450° C. Subsequently, the molten glass was stirred and refined, to thereby obtain a homogeneous molten glass.

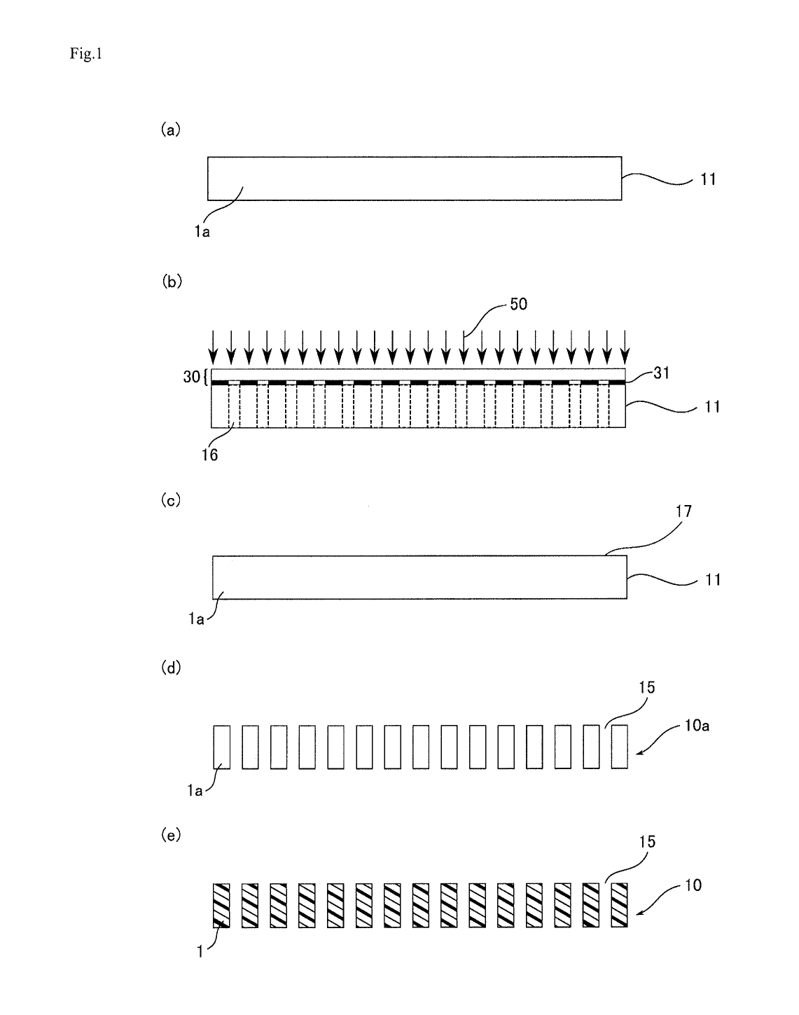

The molten glass is flowed into a prescribed mold so that it is molded into a prescribed shape (for example, a rod shape or a block shape, etc.), which is then annealed, to thereby obtain a photosensitive glass. Then, a cut-out material is obtained from the block of the produced photosensitive glass, to thereby obtain a base material 11 constituted of a photosensitive glass 1a (see FIG. 1(a)).

### (Exposure Step)

Next, as shown in FIG. 1(b), a latent image 16 is formed at a portion serving as a through hole (also referred to as a through hole forming scheduled portion) on the base material 11. A UV-ray 50 is transmitted through a portion where a light shielding film 31 is not formed so that the base material 11 is exposed, to thereby form the latent image 16. In the latent image 16, metal of a photosensitive component exists, which is the component generated by an oxidation-reduction reaction between the photosensitive component (such as Au, etc.) and a photosensitizing component (such as Ce, etc.).

### (First Crystallization Step)

Subsequently, heat treatment is applied to the base material with the latent image formed thereon, so that the latent image is formed on the crystallized portion. As shown in FIG. 1(c), by the heat treatment, the metal is agglomerated to form a colloid in the latent image 16, and a crystal of Li₂O—SiO₂ (lithium mono silicate) is precipitated, with the colloid as a crystal nucleus, to thereby form a crystallized portion 17. Accordingly, similarly to the latent image 16, the crystallized portion 17 is formed at a position corresponding to the through hole forming scheduled portion. The crystallization corresponds to the abovementioned first crystallization, and the photosensitive glass cannot become a silicate ceramics.

In the first crystallization step, the heat treatment is performed in a range of 450 to 600° C. The temperature keeping time is not particularly limited, and it is sufficient to require the time so that the crystal of the lithium monosilicate is sufficiently precipitated, and a size of this crystal is not excessively large. This is because when the size of the crystal is excessively large, accuracy of the fine processing by etching described later, is deteriorated.

### (Through Hole Formation Step)

In the through hole formation step as an example of the fine processing step, as shown in FIG. 1(d), the formed crystallized portion 17 is dissolved and removed by etching using HF (hydrogen fluoride), to thereby form a through hole 15. The crystallized portion 17, that is, lithium monosilicate is easily dissolved in the hydrogen fluoride, compared with a non-crystallized glass portion. Specifically, a difference of a dissolving rate between the crystallized portion 17 and the glass portion other than the crystallized portion, is about 50 times. Accordingly, the difference of the dissolving rate is utilized, the hydrogen fluoride is used, and the hydrogen fluoride is sprayed against both surfaces of the base material 11 using the hydrogen fluoride as an etching solution, to thereby dissolve and remove the crystallized portion 17 and form the through hole 15. Namely, the through hole 15 is formed by applying selective etching to the base material 11.

### (Second Crystallization Step)

In the second crystallization step, heat treatment is applied to the photosensitive glass substrate 10a with the through holes 15 formed thereon, and the photosensitive glass 1a constituting the base material is crystallized, to thereby obtain a plate-like substrate composed of the silicate ceramics 1.

The heat treatment in the second crystallization step, is performed at a higher temperature than the heat treatment in the first crystallization step, and the temperature is kept in a range of 800 to 900° C., and thereafter annealing is performed. The temperature keeping time during the heat treatment is preferably 120 minutes or more. This is because crystallization of the photosensitive glass is accelerated, and the crystallinity can be increased. Further, a cooling rate during annealing is preferably set to be slower than a natural cooling in a furnace, and for example, set to 50° C./hr or less. This is because as the cooling rate is slower and the annealing is longer during annealing, much more lithium disilicate crystal phase is likely to be obtained even if the crystallinity is the same. The entire surface of the plate-like substrate may be irradiated with UV-rays, before the heat treatment of the second crystallization step is performed.

Owing to this heat treatment, the crystal of the lithium disilicate and the crystal of the α-quartz are respectively precipitated in the entire body of the photosensitive glass, and approximately the entire surface of the photosensitive glass is crystallized to become the silicate ceramics. Namely, the plate-like substrate with the through holes formed thereon, is composed of the silicate ceramics.

Since the obtained plate-like substrate is composed of the silicate ceramics, it has an excellent mechanical performance, and is suitably used for the abovementioned application.

### 5. Effect of this Embodiment

According to this embodiment, the silicate ceramics formed by crystallizing the photosensitive glass, can be obtained. The silicate ceramics is composed of the crystal of lithium disilicate and the crystal of the α-quartz, and has a significantly high crystallinity compared to a normal crystallized glass, and has a significantly higher crystallinity compared to the normal crystallized glass, and approximately the entire surface is composed of crystal.

Further, in this embodiment, the weight ratio of the lithium disilicate crystal phase and the α-quartz crystal phase is set in the abovementioned range.

Further, in the silicate ceramics of this embodiment, the crystallite size of the lithium disilicate and the α-quartz is in a range of 20 to 30 nm. Accordingly, both of the lithium disilicate crystal and the α-quartz crystal in the silicate ceramics is significantly fine.

Therefore, the abovementioned silicate ceramics is hardly deformed even if an external force is added thereon. Also, even if a crack occurs in the silicate ceramics due to an external force, the crack is difficult to progress. Accordingly, the silicate ceramics of this embodiment is excellent in the mechanical performance. Specifically, the silicate ceramics having a bending strength of 130 MPa or more can be obtained.

Then, the plate-like substrate composed of such a silicate ceramics, has a significantly high mechanical performance. Accordingly, even in a case of an extremely thin substrate like a substrate having a thickness of 1.0 mm or less, a sufficient mechanical performance can be secured.

Such an effect is remarkably exhibited even when the substrate is thin in thickness, and has a large length in a plane direction, namely, even in a case of a large sized substrate. Specifically, even when the size of the substrate is 50 mm or more, the substrate capable of exhibiting a sufficient mechanical performance can be obtained.

When the plate-like substrate composed of the silicate ceramics having the excellent mechanical performance as described above is produced, the heat treatment temperature is kept in the abovementioned range, and an annealing may be performed at a prescribed cooling rate.

### 6. Modified Example, Etc.

In the abovementioned embodiment, the photosensitive glass is used as the silicate glass. However, a silicate glass not containing the photosensitive component may also be used. In such a silicate glass, only the second crystallization of the abovementioned embodiment occurs.

Further, in the abovementioned embodiment, the formation of the through holes is performed as the fine processing applied to the base material composed of the photosensitive glass. However, other fine processing may also be performed. For example, the formation of the latent image may be performed up to a middle of the base material, and a bottomed hole may be formed.

As described above, explanation has been given for the embodiments of the present invention. However, the present invention is not limited to the abovementioned embodiments, and can be variously modified in a range not departing from the gist of the present invention.

### EXAMPLES

The present invention will be described hereafter, based on further detailed examples. However, the present invention is not limited thereto.

### Example 1

In example 1, the property of the silicate ceramics was evaluated. First, PEG3 by HOYA Corporation was prepared as a photosensitive glass. PEG3 was composed of SiO₂—Li₂O—Al₂O₃ based glass, and had a photosensitive component and a photosensitizing component.

Heat treatment was applied to the PEG3 at each temperature of 500° C., 750° C., 820° C., and 900° C., to thereby obtain a sample. The temperature keeping time during the heat treatment was set to 240 minutes, and a cooling rate during annealing performed after keeping the temperature, was set to 25° C./hr. X-ray diffraction measurement was performed to the obtained sample (PEG3 after the heat treatment). Cu-Kα ray was used as an X-ray source, and measurement conditions were set as follows; a tube voltage: 45 kV, a tube current: 200 mA, a scan range: 5 to 80°, a scanning step: 0.04°, and a scan speed: 10°/min.

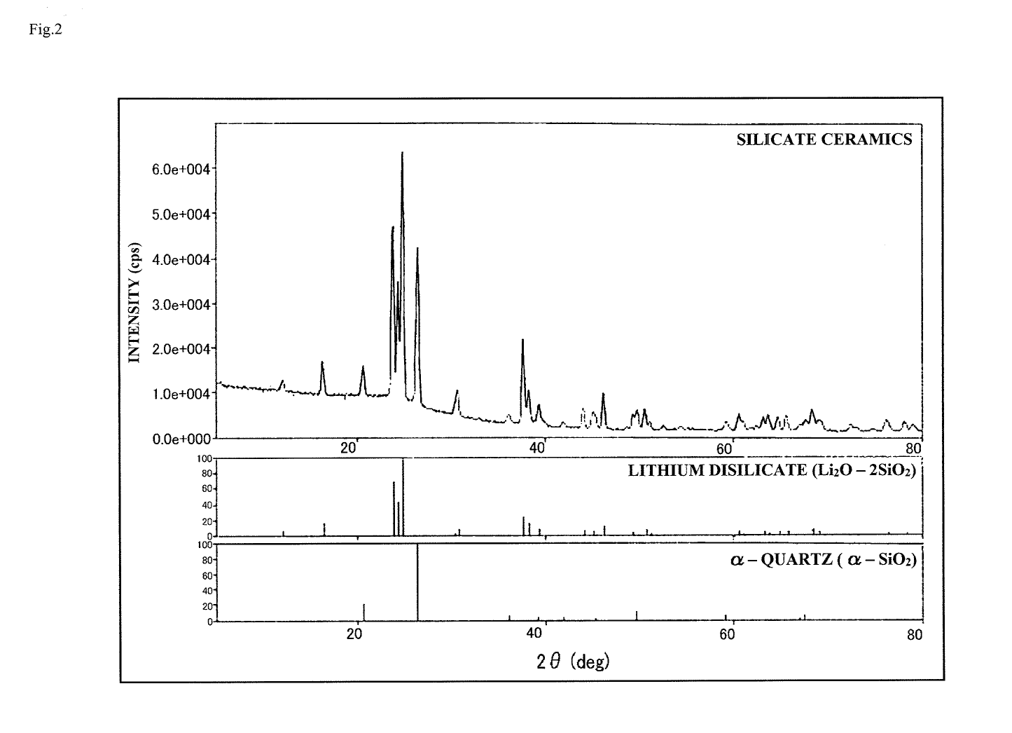

FIG. 2 shows an X-ray diffraction profile of the PEGS (sample No. 4) subjected to the heat treatment at 870° C. Regarding each sample (sample No. 1 to 5), the crystallinity, the weight ratio of the crystal phase, and the crystallite size were calculated as follows, based on the obtained X-ray diffraction profile. Regarding the crystallite size, only the sample (sample No. 4) subjected to the heat treatment at 870° C., was calculated.

### (Crystallinity)

The crystallinity was calculated by the abovementioned formula (1) from the obtained X-ray diffraction profile by separating a total scattering intensity of the X-ray into a crystal scattering intensity and a non-crystal scattering intensity. The result is shown in table 1.

### (Weight Ratio of the Crystal Phase)

From the obtained X-ray diffraction profile, the weight ratio of the crystal phase was calculated by a ratio of a peak intensity resulting from (111) plane of lithium disilicate and a peak intensity resulting from (011) plane of α-quartz. The result is shown in table 1.

### (Crystallite Size)

From the obtained X-ray diffraction profile, the crystallite size was calculated by a Scherrer's formula, using a half value width of a peak resulting from the (111) plane of the lithium disiliate, and a half value width of a peak resulting from the (011) plane of the α-quartz. The result is shown in table 1.

### (Bending Strength)

Further, the sample of PEG3 after the heat treatment was processed, to fabricate a test piece having a total length of 40 mm, a width of 4 mm, and a thickness of 3 mm. Three-point bending strength was measured for the obtained test piece, in compliance with JIS R 1601. Measurement conditions were set as follows; a support span: 30 mm, and a cross-head speed: 0.5 mm/min. In the measurement of the bending strength, ten test pieces in each sample were measured, and an average value thereof was defined as a bending strength value. The result is shown in table 1. The bending strength of the sample (sample No. 4) subjected to heat treatment at 870° C. was not measured. For reference, the bending strength of alumina (Al₂O₃) was 350 MPa, and the bending strength of silicon carbide (SiC) was 400 MPa, which were performed under the same condition.

TABLE 1

| | | Silicate ceramics | | | | | |
|---|---|---|---|---|---|---|---|
| | | | | | | | Mechanical |
| | | | Ratio of crystal | | | | performance |
| | Heat | | phase (wt %) | | Crystallite size (nm) | | Bending |
| | treatment | Crystallinity | Lihium | | Lihium | | strength |
| Sample No. | condition | (%) | disilicate | α - quartz | disilicate | α - quartz | (MPa) |
| 1 | 500° C.-4 h | — | — | — | — | — | 60 |
| 2 | 750° C.-4 h | 95 | 50 | 50 | — | — | 80 |
| 3 | 820° C.-4 h | 97 | 60 | 40 | — | — | 130 |
| 4 | 870° C.-4 h | 100 | 68 | 32 | 29.1 | 25.7 | — |
| 5 | 900° C.-4 h | 100 | 70 | 30 | — | — | 150 |

In the sample (sample No. 1) whose heat treatment temperature was 500° C., scattering (halo) by an amorphous material was observed in the X-ray diffraction profile, and it was confirmed that a specific peak could not be obtained, and the sample was in a glassy state. Therefore, as described in table 1, the crystallinity could not be calculated. Also, in the sample (sample No. 2) whose heat treatment temperature was 750° C., although the crystallinity was significantly high, it was confirmed that the weight ratio of the crystal phase didn't satisfy the abovementioned range, and therefore the bending strength was low.

Meanwhile, regarding the weight ratio of the crystal phase in the sample (sample No. 3) whose heat treatment temperature was 820° C., it was confirmed that the ratio of the lithium silicate was larger than the ratio of the α-quartz and the bending strength was strong. In the sample (sample No. 4) whose heat temperature was 870° C., a sharp diffraction peak belonging to the lithium disiilcate and the α-quartz could be observed in FIG. 2. Further, from table 1, it was confirmed that the crystallinity calculated from the X-ray diffraction profile of FIG. 2 was 100%, and the PEG3 was completely crystallized and turned into a polycrystalline body (silicate ceramics). Further, regarding the weight ratio of the crystal phase, it was confirmed that the ratio of the lithium disilicate was larger than the ratio of the α-quartz, in the abovementioned range. It was also confirmed that the crystallite size was significantly fine.

Further, regarding the sample (sample No. 5) whose teat treatment temperature was 900° C., an X-ray diffraction profile similar to the X-ray diffraction profile shown in FIG. 2, was obtained. As a result, it was confirmed that the crystallinity of the sample No. 5 was 100% similarly to sample No. 4, and the weight ratio of the crystal phase was in the abovementioned range. Accordingly, the three-point bending strength of the sample No. 5 was significantly higher than a case when the heat treatment temperature was low (sample No. 1 and 2), and remarkable effects could be confirmed in the sample No. 1 and 2.

Further, separately from the sample No. 1 to 5, heat treatment was applied to the PEG3 at a temperature of 750° C., by setting the temperature keeping time at 240 minutes, and at a cooling rate of 20° C./hr during annealing after keeping the temperature, to thereby obtain a sample. As a result of performing the X-ray diffraction measurement similarly to above, it was confirmed that the crystallinity was 95%, the weight ratio of the crystal phase was lithium disilicate:α-quartz=55:45, and the bending strength was strong.

### Example 2

In examples 2 and 3, the base material having the through holes was crystallized to obtain the silicate ceramics to fabricate the plate-like substrate, and evaluation was performed thereto. As the base material, PEG3 by HOYA Corporation was prepared. This base material has a disc shape, and its dimension was φ200 mm in the diameter, and 0.5 mm in the thickness.

Subsequently, a photomask was superimposed on the base material, the photomask having a pattern in which the through holes having a diameter of 50 μm were arranged at an arrangement pitch of 200 μm and formed in a range of φ170 mm, and a proximity exposure was performed to this pattern by the UV-ray, to thereby form a latent image on the base material. Next, as a first crystallization, the base material was charged into a convectional oven, and the heat treatment was applied thereto at 600° C., to crystallize the latent image. Subsequently, etching treatment was applied to front and rear surfaces using a hydrogen fluoride-based etching solution, so that a crystallized portion was dissolved and removed and the through holes were formed on the base material, to thereby obtain a plate-like substrate having the through holes.

As a second crystallization, the obtained plate-like substrate was charged into the convectional oven, and the heat treatment was applied thereto at 850° C., so that the photosensitive glass constituting the plate-like substrate was crystallized, to thereby obtain silicate ceramics. The temperature keeping time during the heat treatment was set to 300 minutes, and annealing was performed after keeping the temperature. The cooling rate during gradual cooing was set to 25° C./hr. As a result of performing the X-ray diffraction measurement for the plate-like substrate after the second crystallization, it was found that the crystallinity was 99%, the weight ratio of the crystal phase was lithium disilicate:α-quartz=68:32.

Cu electrodes were formed on both surfaces of the plate-like substrate composed of the silicate ceramics, and further each through hole was filled with Cu by electrolytic plating method. Thereafter, the plate-like substrate was polished from both surfaces in a thickness of 0.1 mm, to obtain an interposer having the through hole filled with Cu.

Eight interposers were stored in a shipping case having slits in vertical placement, and transported through a distance of 500 km by a truck. As a result, it was confirmed that there was no damage in a total number of the stored interposers, and this interposer was capable of exhibiting an excellent mechanical strength.

### Example 3

First, PEG3 by HOYA Corporation was prepared as the base material. The base material had a square plate shape, and has a dimension of 150 mm square in diameter and 0.5 mm in thickness.

Subsequently, a photomask was superimposed on the base material, the photomask having a pattern in which the through holes having a diameter of 50 μm were arranged at an arrangement pitch of 200 μm, and formed in a range of 100 mm square, and a proximity exposure was performed to this pattern by the UV-ray, to thereby form a latent image on the base material. Next, as a first crystallization, the base material was charged into a convectional oven, and the heat treatment was applied thereto at 600° C., to crystallize the latent image. Subsequently, etching treatment was applied from front and rear surfaces using a hydrogen fluoride-based etching solution, so that a crystallized portion was dissolved and removed and the through holes were formed on the base material, to thereby obtain a plate-like substrate having the through holes.

As a second crystallization, the obtained plate-like substrate was charged into the convectional oven, and heat treatment was applied thereto at 900° C., so that the photosensitive glass constituting the plate-like substrate is crystallized, to thereby obtain silicate ceramics. The temperature keeping time during heat treatment was set to 420 minutes, and an annealing was performed after keeping the temperature. The cooling rate during annealing was set to 25° C./hr. Regarding the plate-like substrate after the second crystallization, as a result of performing the X-ray diffraction measurement, it was found that the crystallinity was 99%, the weight ratio of the crystal phase was lithium disilicate:α-quartz=68:32.

Cu electrode was formed on one of the surfaces of the plate-like substrate composed of the silicate ceramics, and dry etching was performed to an inside of the through hole through the through hole from the other surface, and Cu formed inside of the through hole was removed. Subsequently, Cu electrode was formed on the other surface, and similarly, Cu formed inside of the through hole was removed. Thus, a gas electron amplifying substrate was obtained, in which Cu was not formed inside of the through hole, and Cu electrodes were formed on both surfaces.

Eight gas electron amplifying substrates were stored in a shipping case having slits in vertical placement, and transported through a distance of 500 km by a truck. As a result, it was confirmed that there was no damage in a total number of the stored interposers, and this electron amplifying substrate was capable of exhibiting an excellent mechanical strength.

### DESCRIPTION OF SIGNS AND NUMERALS

1 Silicate ceramics
1a Photosensitive glass
10 Plate-like substrate
11 Base material
15 Through hole
16 Latent image
17 Crystallized portion

1. A silicate ceramics formed by crystallizing a silicate glass containing at least silicon oxide and lithium oxide, wherein a crystallinity of the silicate ceramics is 95% or more, and the silicate ceramics has a lithium disilicate crystal phase and α-quartz crystal phase, and further, regarding the ratio of the lithium disilicate crystal phase and the α-quartz crystal phase in the silicate ceramics, the lithium disilicate crystal phase has a larger weight ratio.

2. The silicate ceramics according to claim 1, wherein the ratio of the lithium disilicate crystal phase and the α-quartz crystal phase is 60:40 to 80:20 by weight ratio.

3. The silicate ceramics according to claim 1, wherein the silicate glass is a photosensitive glass.

4. The silicate ceramics according to claim 1, wherein a bending strength of the silicate ceramics is 130 MPa or more.

5. The silicate ceramics according to claim 1, wherein a crystallite size of the lithium disilicate crystal and the α-quartz crystal phase is within a range of 20 to 30 nm.

6. A plate-like substrate, which is made of the silicate ceramics of claim 1, and having a plurality of through holes thereon, with a thickness of 1.0 mm or less.

7. The plate-like substrate according to claim 6, wherein a diameter of the plate-like substrate is 50 mm or more.

8. A method of producing a plate-like substrate, comprising:
applying a fine processing to a plate-like base material made of a photosensitive glass containing at least silicon oxide and lithium oxide; and
crystallizing a photosensitive glass by heat treatment after the fine processing, to obtain a plate-like substrate made of the silicate ceramics of claim 1.

9. The method of producing a plate-like substrate according to claim 8, wherein the photosensitive glass is annealed after holding it at a temperature range of 800 to 900° C. in the heat treatment.
